(19) United States
(12) Patent Application Publication
(10) Pub. No.: US 2022/0309348 A1
(43) Pub. Date: Sep. 29, 2022

(54) METHOD FOR GENERATING PERSONALIZED DIALOGUE CONTENT

(71) Applicant: Northwestern Polytechnical University, Xi'an (CN)

(72) Inventors: Bin Guo, Xi'an (CN); Hao Wang, Xi'an (CN); Zhiwen Yu, Xi'an (CN); Zhu Wang, Xi'an (CN); Yunji Liang, Xi'an (CN); Shaoyang Hao, Xi'an (CN)

(21) Appl. No.: 17/725,480

(22) Filed: Apr. 20, 2022

Related U.S. Application Data
(63) Continuation of application No. PCT/CN2020/117265, filed on Sep. 24, 2020.

(30) Foreign Application Priority Data
Oct. 24, 2019 (CN) 201911015873.9

(51) Int. Cl. G06N 3/08; G06F 40/35; G06F 40/44

(52) U.S. Cl. CPC G06N 3/08; G06F 40/35; G06F 40/44

(57) ABSTRACT

The disclosure relates to a method for generating personalized dialogue content, in which an implicit association between personalized characteristics and corresponding dialogue replies is extracted by collecting a set of personalized dialogue data; a vector representation of a dialogue context and texts of the personalized characteristics is learned with a Transformer model; finally, through learning a sequence dependency between natural languages, a subsequent content may be automatically predicted and generated from a previous text, so that the generating of corresponding reply content may be achieved according to the dialogue context. With various optimization algorithms added, a generation probability of universal reply can be reduced and a diversity of the generated dialogue content can be improved.

### CROSS-REFERENCE TO RELATED APPLICATION(S)

This application claims priority to and the benefit of Chinese Patent Application Serial No. 201911015873.9, filed Oct. 24, 2019, the entire disclosure of which is hereby incorporated by reference.

### TECHNICAL FIELD

The disclosure relates to the field of deep learning, in particular to a method for generating personalized dialogue content.

### BACKGROUND

Natural language processing (NLP) is a very important branch of artificial intelligence, in which various theories and methods for realizing an effective communication between a person and a computer using a natural language can be studied. Text generation, namely natural language generation, is a very important research direction in the natural language processing, in which high-quality natural language texts with fluency, smoothness and clear semantics can be automatically generated with various types of information, such as texts, structured information and images. A dialogue system is a very important research direction in the text generation and human-computer interactions, and various forms of the dialogue system are developing rapidly. A social chat robot, namely a human-machine dialogue system that may communicate with human beings, is one of longest-lasting research concerns in the artificial intelligence.

In recent years, a research of the dialogue system based on a deep neural network has made great progress, and it has been applied more and more widely in daily life, such as well-known Microsoft XiaoIce and Apple Siri. Deep neural network models used in the research of the dialogue system generally includes: Recurrent Neural Network (RNN), which captures information in text sequences with a natural sequence structure; Generative Adversarial Network (GAN) and Reinforcement learning, which learn hidden principles in a natural language by imitating human learning; Variational Autoencoder (VAE), which introduces variability into a model by hiding a variables distribution so as to improve diversity of generated contents, but there are still shortcomings in an accuracy of diversified personalization in a dialogue process.

### SUMMARY

In view of above shortcomings, the present disclosure provides a method for generating diversified personalized dialogue content. Technical schemes of the disclosure are as follows.

A method for generating diversified personalized dialogue content.

Further, the method includes following steps:

step 1: collecting a set of personalized dialogue data and preprocessing the data, dividing the set of personalized dialogue data into a training set, a verification set and a test set to provide a support for subsequent training of a model;

step 2: defining an input sequence X={x₁, x₂, . . . , xₙ} of the model, which includes n words in an input sentence sequence; word embedding all of the words in the input sequence to obtain corresponding word embeded vectors, then performing a position encoding, and correspondingly adding the word embeded vectors and position encoded vectors to obtain an input vector representation of the model;

step 3: entering an encoding stage, in which the word vectors in the sentence sequence is updated according to a context with a multi-head attention module, so as to obtain an output of the encoding stage via a feedforward neural network layer with following formula:

FFN(Z)=max(0,Z,W₁+b₁)W₂+b₂,

where Z indicates output content of a multi-head attention layer;

step 4: entering a decoding stage, in which an input of the decoding stage is also subjected to word embedding and position encoding to obtain a vector representation of an input; the input vector is updated with the multi-head attention mechanism, then influences of input content at different times, historical dialogue content and different personalized characteristics on an output at current time are determined by an encoding-decoding attention mechanism with a same structure, and finally an output of the decoding stage is obtained via the feedforward neural network layer; and

step 5: learning parameters of the model with a negative logarithm likelihood function loss of the minimum generated sequence so as to obtain a personalized multi-turn dialogue content generation model, a formula for the negative logarithm likelihood function loss being as follows:

$${L}_{TokNLL} = - {\sum }_{i = 1}^{n} log p ( {t}_{i} \vert {t}_{1} , … , {t}_{i - 1} , x )$$

where, t¹, . . . , tᵢ indicates the i-th word in the generated sentence sequence. Further, a formula used in the position encoding in the step 2 is as follows:

$$PE ( pos , 2 i ) = sin ( \frac{pos}{{10000}^{{d}_{model}^{2 i}}} )$$

$$PE ( pos , 2 i + 1 ) = cos ( \frac{pos}{{10000}^{{d}_{model}^{2 i}}} )$$

where, PE(pos, 2i) indicates a value in a 2i-th dimension of the pos-th word in the sentence sequence, and PE(pos, 2i+1) indicates a value in a 2i+1-th dimension of the pos-th word in the sentence sequence.

Further, the input content of the model in the step 2 includes not only the current dialogue content, but also all of the historical dialogue content that have occurred as well as specific personalized characteristics.

Further, a formula for the updating of the word vector in the step 3 is as follows:

$$MultiHead ( Q , K , V ) = Concat ( {head}_{1} , {head}_{2} , … {head}_{k} ) {W}^{O} ,$$

$${head}_{i} = Attention ( {QW}_{i}^{Q} , {KW}_{i}^{K} , {VW}_{i}^{V} )$$

$$Attention ( Q , K , V ) = softmax ( \frac{{QK}^{T}}{\sqrt{{d}_{k}}} ) V$$

where, Q,K,V are respectively obtained by multiplying three different weight matrices by the input vector of the model, and headᵢ indicates an attention head in the multi-head attention mechanism.

Further, a residual connection and layer normalization process is added to the multi-head attention layer and feedforward neural network layer in the encoding stage in the step 3, and the residual connection and layer normalization process is also added to each sublayer in the decoding stage in the step 4; a formula for the residual connection and layer normalization process is as follows:

SubLayerₒᵤₜₚᵤₜ=LayerNorm(x+(SubLayer(x))

Where, SubLayer indicates the multi-head attention layer or feedforward neural network layer. Further, the method further involves a diversified personalized dialogue content generation model, in which various optimization algorithms including a diversified bundle search algorithm with length penalty and a label smoothing algorithm are added to the personalized multi-turn dialogue model, so as to improve diversity of the generated dialogue content and realize the diversified personalized multi-turn dialogue model.

Further, the method further includes adding an optimization algorithm to improve the diversity of the generated content, in which firstly, a label smoothing term is added to the loss function to prevent the model from excessively concentrating predicted values on a category with a higher probability, thus reducing a possibility of generating universal reply content, the loss function with the label smoothing term added being:

$${L}_{TokLS} = - {\sum }_{i = 1}^{n} log p ( {t}_{i} \vert {t}_{1} , … , {t}_{i - 1} , x ) - {D}_{KL} ( f \vert \vert p ( {t}_{i} \vert {t}_{1} , … , {t}_{i - 1} , x )$$

Where f indicates a uniform prior distribution independent of the input,

$$f = \frac{1}{V} ,$$

V is a size of a wordlist; then the diversified bundle search algorithm with length penalty is added in a test stage, so that with a punishing of a sequence length,

a probability of generating a short sequence is reduced and a possibility of generating a long sequence by the model is improved; B words with highest probabilities at every decoding time are selected as an output at the current time, and specifically, conditional probabilities of all words on the B words at the current time are respectively calculated according to a probability distribution of B optimal words selected at a previous time in a predicting process, and B word sequences with the highest probabilities are selected as the output at the current time; and B sentence sequences are grouped with similarity penalty between groups added to reduce the probability of generating similar content and improve the diversity of the content generated by the model.

The disclosure has beneficial effects as follows: first, an implicit association between personalized characteristics and corresponding dialogue replies is extracted by collecting a set of personalized dialogue data; next, a vector representation of a dialogue context and texts of the personalized characteristics is learned with a Transformer model; finally, through learning a sequence dependency between natural languages, a subsequent content may be automatically predicted and generated from a previous text, so that the generating of corresponding reply content may be achieved according to the dialogue context. With various optimization algorithms added, a generation probability of universal reply can be reduced and a diversity of the generated dialogue content can be improved.

### BRIEF DESCRIPTION OF THE DRAWINGS

FIG. 1 is an overall structure diagram of a personalized dialogue model according to the present disclosure;

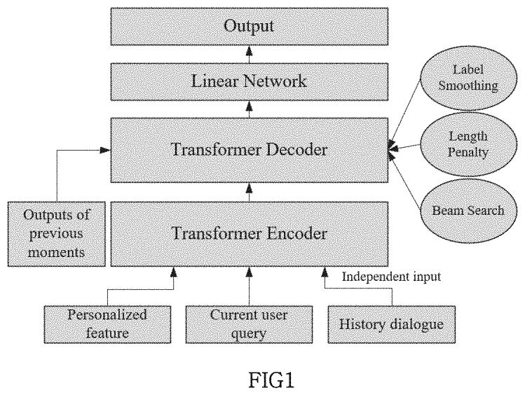

FIG. 2 is a diagram of a model for personalized dialogue content generation in a decoding stage according to the present disclosure; and

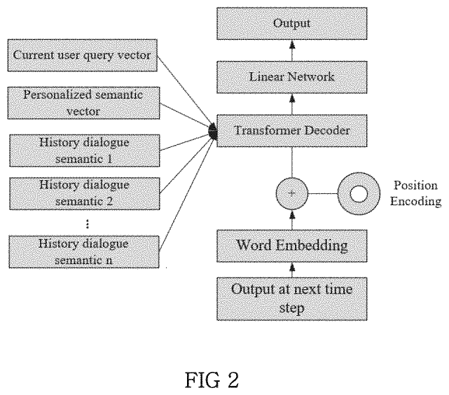

FIG. 3 is a diagram of a model for personalized dialogue content generation in an encoding stage according to the present disclosure.

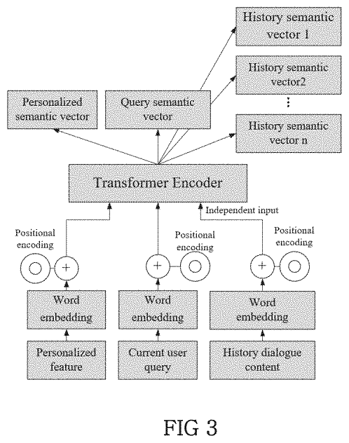

### DETAILED DESCRIPTION

Technical schemes of the present disclosure will be further described in the following with reference to the drawings. A method for generating diversified personalized dialogue content is provided, which includes following steps.

Step 1: large-scale and high-quality universal dialogue datasets and personalized datasets are collected, and divided into a training set, a verification set and a test set in proportion, and then each dialogue in the C₁, C₂, . . . , Cₙ datasets is preprocessed into a format of Dialog={(C₁=, C₂, . . . Cₙ, Q, R}, in which indicates a historical dialogue content, Q indicates a last sentence of the input dialogue, R indicates a corresponding reply, all of them are sentences consist of word sequences. The dataset is converted into a format required for the model for model training.

Step 2: a universal dialogue model is trained with the universal dialogue datasets. An input sequence X={x₁, x₂, . . . , xₙ} of the model is defined, which indicates n words in an input sentence sequence. The input content to the model includes not only the current dialogue content, but also all of historical dialogues that have occurred. All of words in the input sequence are word embedded to obtain corresponding word embedded vectors, and then a position encoding is carried out as follows:

$$PE ( pos , 2 i ) = sin ( \frac{pos}{{10000}^{\frac{2 i}{{d}_{model}}}} )$$

$$PE ( pos , 2 i + 1 ) = cos ( \frac{pos}{{10000}^{\frac{2 i}{{d}_{model}}}} )$$

where, PE(pos, 2i) indicates a value in a 2i-th dimension of the pos-th word in the sentence sequence, and PE(pos, 2i+1) indicates a value in a 2i+1-th dimension of the pos-th word in the sentence sequence. Then the word embedded vectors of the words are correspondingly added with the position encoded vectors to obtain a vector representation of the model input.

Step 3: a model encoding structure is constructed, in which the word vectors in the sentence sequence is updated according to a context with a multi-head attention module as follows:

$$MultiHead ( Q , K , V ) = Concat ( {head}_{1} , {head}_{2} , … {head}_{k} ) {W}^{O} ,$$

$${head}_{i} = Attention ( {QW}_{i}^{Q} , {KW}_{i}^{K} , {VW}_{i}^{V} )$$

$$Attention ( Q , K , V ) = softmax ( \frac{{QK}^{T}}{\sqrt{{d}_{k}}} ) V$$

where, Q,K,V are respectively obtained by multiplying three different weight matrices by the input vector of the model, and headᵢ indicates an attention head in the multi-head attention mechanism.

then an output of the encoding stage is obtained via a feedforward neural network layer which is calculated as follows:

[symbol]

$$FFN ( Z ) = max ( 0 , Z , {W}_{1} + {b}_{1} ) {W}_{2} + {b}_{2}$$

where Z indicates the output content of the multi-head attention layer. A residual connection and layer normalization process is added to the multi-head attention layer and feedforward neural network layer in the encoding stage as follows:

SubLayerₒᵤₜₚᵤₜ=LayerNorm(x+(SubLayer(x))

where, SubLayer indicates the multi-head attention layer or feedforward neural network layer.

Step 4: a model decoding structure is constructed, in which an input of the decoding stage is also subjected to word embedding and position encoding to obtain the vector representation of the input. The input vector is updated with the multi-head attention mechanism, then influences of input content at different times, historical dialogue content and different personalized characteristics on an output at current time are determined by an encoding-decoding attention mechanism with a same structure, and finally an output of the decoding stage is obtained via the feedforward neural network layer. The residual connection and layer normalization process is also added to each sublayer in the decoding stage.

Step 5: parameters of the model with a negative logarithm likelihood function loss of the minimum generated sequence is learned, so as to obtain a universal multi-turn dialogue content generation model as follows:

$${L}_{TokNLL} = - {\sum }_{i = 1}^{n} log p ( {t}_{i} \vert {t}_{1} , … , {t}_{i - 1} , x )$$

where, t₁, . . . , tᵢ indicates the i-th word in the generated sentence sequence. After training is done, the universal multi-turn dialogue model is saved as a start point of training the personalized dialogue model.

Step 6: an encoded part of the personalized characteristics is added into an encoding module of the universal dialogue model, specific personalized characteristic together with the input at the current time and the historical dialogue content as input to the model are encoded, with remaining structures of the model remain unchanged, and then a fine adjustment is made for the universal multi-turn dialogue model with the personalized dialogue datasets, so as to train to obtain a personalized multi-turn dialogue content generation model.

Step 7: various optimization algorithms are added to the personalized multi-turn dialogue model, so as to improve diversity of the generated content by the model. Firstly, a label smoothing term is added to the loss function to prevent the model from excessively concentrating predicted values on a category with a higher probability, thus reducing a possibility of generating universal reply content, the loss function with the label smoothing term added being:

$${L}_{TokLS} = - {\sum }_{i = 1}^{n} log p ( {t}_{i} \vert {t}_{1} , … , {t}_{i - 1} , x ) - {D}_{KL} ( f \vert \vert p ( {t}_{i} \vert {t}_{1} , … , {t}_{i - 1} , x )$$

Where, J indicates a uniform prior distribution independent of the input

$$f = \frac{1}{V} ,$$

V is a size of a wordlist. Then the diversified bundle search algorithm with length penalty is added in the test stage, so that with a punishing of a sequence length, a probability of generating a short sequence is reduced and a possibility of generating a long sequence by the model is improved; B words with highest probabilities at every decoding time are selected as an output at the current time, and specifically, conditional probabilities of all words on the B words are respectively calculated at the current time according to a probability distribution of B optimal words selected at a previous time in a predicting process, and B word sequences with the highest probabilities are selected as the output at the current time. Then B sentence sequences are grouped with similarity penalty added between groups to reduce the probability of generating similar content and improve the diversity of the content generated by the model.

The disclosure relates to a method for generating a personalized dialogue content, in which an implicit association between data may be learned from a quantity of dialogue data using a neural network; a vector representation of a dialogue context and texts of the personalized characteristics is learned with a Transformer model; finally, through learning a sequence dependency between natural languages, a subsequent content may be automatically predicted and generated from a previous text, so that the generating of corresponding reply content may be achieved according to the dialogue context. With various optimization algorithms added, a generation probability of universal reply can be reduced and a diversity of the generated dialogue content can be improved.

What is claimed is:

1. A method for generating personalized dialogue content, comprising following steps:
step 1: collecting a set of personalized dialogue data and preprocessing the data, dividing the set of personalized dialogue data into a training set, a verification set and a test set to provide a support for subsequent training of a model;
step 2: defining an input X={x₁, x₂, . . . , x_{N}} sequence of the model, which includes n words in an input sentence sequence; word embedding all of the words in the input sequence to obtain corresponding word embeded vectors, then performing a position encoding, and correspondingly adding the word embeded vectors and position encoded vectors to obtain an input vector representation of the model;
step 3: entering an encoding stage, in which the word vectors in the sentence sequence is updated according to a context with a multi-head attention module, so as to obtain an output of the encoding stage via a feedforward neural network layer with following formula:
FFN(Z)=max(0,Z,W₁+b₁)W₂+b₂
in which Z indicates output content of a multi-head attention layer;
step 4: entering a decoding stage, in which an input of the decoding stage is also subjected to word embedding and position encoding to obtain a vector representation of an input; the input vector is updated with the multi-head attention mechanism, then influences of input content at different times, historical dialogue content and different personalized characteristics on an output at current time are determined by an encoding-decoding attention mechanism with a same structure, and finally an output of the decoding stage is obtained via the feedforward neural network layer; and
step 5: learning parameters of the model with a negative logarithm likelihood function loss of the minimum generated sequence so as to obtain a personalized multi-turn dialogue content generation model, a formula for the negative logarithm likelihood function loss being as follows:
$${L}_{TokLS} = - {\sum }_{i = 1}^{n} log p ( {t}_{i} \vert {t}_{1} , … , {t}_{i - 1} , x )$$
where, t₁, . . . tᵢ indicates the i-th word in the generated sentence sequence.

2. The method according to claim 1, wherein a position encoding formula in step 2 is:
$$PE ( pos , 2 i ) = sin ( \frac{pos}{{10000}^{\frac{2 i}{{d}_{model}}}} )$$
$$PE ( pos , 2 i + 1 ) = cos ( \frac{pos}{{10000}^{{d}_{model}^{2 i}}} )$$
where, PE(pos, 2i) indicates a value in a 2i-th dimension of the pos-th word in the sentence sequence, and PE(pos, 2i+1) indicates a value in a 2i+1-th dimension of the pos-th word in the sentence sequence.

3. The method according to claim 1, wherein the input content of the model in the step 2 comprises not only the current dialogue content, but also all of the historical dialogue content that have occurred as well as specific personalized characteristics.

4. The method according to claim 1, wherein a formula for updating of the word vector in the step 3 is as follows:
$$MultiHead ( Q , K , V ) = Concat ( {head}_{1} , {head}_{2} , … {head}_{k} ) {W}^{0} ,$$
$${head}_{i} = Attention ( {QW}_{i}^{Q} , {KW}_{i}^{K} , {VW}_{i}^{V} )$$
$$Attention ( Q , K , V ) = softmax ( \frac{{QK}^{T}}{\sqrt{{d}_{k}}} ) V$$
where, Q,K,V are respectively obtained by multiplying three different weight matrices by the input vector of the model, and headᵢ indicates an attention head in the multi-head attention mechanism.

5. The method according to claim 1, wherein a residual connection and layer normalization process is added to the multi-head attention layer and feedforward neural network layer in the encoding stage in the step 3, and the residual connection and layer normalization processes is also added to each sublayer in the decoding stage in the step 4, a formula for the residual connection and layer normalization process is as follows:
SubLayerₒᵤₜₚᵤₜ=LayerNorm(x+(SubLayer(x))
where, SubLayer indicates the multi-head attention layer or feedforward neural network layer.

6. The method according to claim 1, further comprising a diversified personalized dialogue content generation model, in which various optimization algorithms including a diversified bundle search algorithm with length penalty and a label smoothing algorithm are added to the personalized multi-turn dialogue model, so as to improve diversity of the generated dialogue content and realize the diversified personalized multi-turn dialogue model.

7. The method according to claim 1, comprising adding an optimization algorithm to improve the diversity of the generated content, in which firstly, a label smoothing term is added to the loss function to prevent the model from excessively concentrating predicted values on a category with a higher probability, thus reducing a possibility of generating universal reply content, the loss function with the label smoothing term added being:
$${L}_{TokLS} = - {\sum }_{i = 1}^{n} log p ( {t}_{i} \vert {t}_{1} , … , {t}_{i - 1} , x ) - {D}_{KL} ( f \vert \vert p ( {t}_{i} \vert {t}_{1} , … , {t}_{i - 1} , x )$$
where, f indicates a uniform prior distribution independent of the input,
$$f = \frac{1}{V} ,$$
V is a size of a wordlist; and then the diversified bundle search algorithm with length penalty is added in a test stage, so that with a punishing of a sequence length, a probability of generating a short sequence is reduced and a possibility of generating a long sequence by the model is improved; B words with highest probabilities at every decoding time are selected as an output at the current time, and specifically, conditional probabilities of all words on the B words are respectively calculated at the current time according to a probability distribution of B optimal words selected at a previous time in a predicting process, and B word sequences with the highest probabilities are selected as the output at the current time; and B sentence sequences are grouped with similarity penalty added between groups to reduce the probability of generating similar content and improve the diversity of the content generated by the model.
